(19) United States
(12) Patent Application Publication
(10) Pub. No.: US 2008/0040929 A1
(43) Pub. Date: Feb. 21, 2008

(54) Pocketknife with a folding blade and a secondary blade

(76) Inventor: Chi-Tung Chu, Taipei Hsien (TW)

Correspondence Address: HERSHKOVITZ & ASSOCIATES, 2845 DUKE STREET, ALEXANDRIA, VA, 22314, US

(21) Appl. No.: 11/505,924

(22) Filed: Aug. 18, 2006

(51) Int. Cl. B26B 11/00

(52) U.S. Cl. 30/143; 30/152

(57) ABSTRACT

A pocketknife with a folding blade and a secondary blade has a handle, a folding blade, a bracket and a secondary blade. The handle has a side. The folding blade is attached pivotally to the handle and has a bottom edge and a cutting edge. The cutting edge is formed on the bottom edge of the folding blade. The bracket is mounted on the side of the handle. The secondary blade is slidely mounted inside the bracket and has a bottom edge and a cutting edge. The cutting edge is formed on the bottom edge of the secondary blade. The cutting edges on the blades are separated from each other. The cutting edge on the secondary blade cannot interfere with the cutting edge of the folding blade. The cutting edge of the secondary blade is long enough to cut things with a few strokes.

### BACKGROUND OF THE INVENTION

1. Field of the Invention

The present invention relates to a pocketknife, and more particularly to a pocketknife with a folding blade and a secondary blade that allows the folding knife to cut and slice things more conveniently.

2. Description of Related Art

Pocketknives are used in camping, fishing, hunting and daily life to cut and slice things.

With reference to FIGS. 7 and 8, a conventional pocketknife in accordance with prior art comprises a blade (50) and a handle (60).

The blade (50) has a proximal end, a latch notch (51), a pivot hole (52), a bottom edge, a cutting edge (53), a serrated edge (54), a side and a detent (55). The latch notch (51) is formed in the proximal end of the blade (50). The pivot hole (52) is formed through the proximal end of the blade (50) near the latch notch (51). The cutting edge (53) and the serrated edge (54) are formed on the bottom edge of the blade (50) adjacent to each other. However, a user needs to be particularly watchful and meticulous when use of the serrated edge (54) or the cutting edge (53) of the blade (50) is not appropriate. The detent (55) is formed in the side of the blade near the pivot hole (52).

The handle (60) has a main half-handle (61), a stationary piece (62), a secondary half-handle (63), a pivot pin (65) and a bolt (64).

The main half-handle (61) has an inner side, a recess (611), a front end and a mounting hole (612). The recess (611) is formed in the inner side of the main half-handle (61). The mounting hole (612) is formed through the front end of the main half-handle (61) and aligns with the pivot hole (52) in the blade (50).

The stationary piece (62) is mounted in the recess (611) in the main half-handle (61) against the proximal end of the blade (50) and has a latch (621), a front end and a through hole (623). The latch (621) is formed on the stationary piece (62) and has a side and a protrusion (622). The protrusion (622) is formed on the side of the latch (621), protrudes toward the blade (50) and selectively aligns with and engages the detent (55) in the blade (50) to hold the blade (50) in a closed position inside the handle (60). The through hole (623) is formed through the front end of the stationary piece (62) and aligns with the mounting hole (612) in the main half-handle (61) and the pivot hole (52) in the blade (50). The secondary half-handle (63) is connected to the main half-handle (61), slidably abuts the proximal end of the blade (50), holds the blade (50) when the blade (50) is folded into the handle (60) and has a front end and a mounting hole (631). The mounting hole (631) is formed through the secondary half-handle (63) near the front end and aligns with the pivot hole (52) in the blade (50), the through hole (623) in the stationary piece (62) and the mounting hole (612) in the main half-handle (61). The pivot pin (65) is mounted in and protrudes from the mounting hole (612) in the main half-handle (61) and extends through the through hole (623) in the stationary piece (62) and the pivot hole (52) in the blade (50) and into the mounting hole (631) in the secondary half-handle (63). The bolt (64) extends into the mounting hole (631) in the secondary half-handle (63) and screws into the pivot pin (65) to hold the blade (50) pivotally between the main half-handle (61) and the secondary half-handle (63) and against the stationary piece (62).

When the blade (50) is pulled out of the handle (60), the latch (621) on the stationary piece (62) engages the latch notch (51) and the proximal end of the blade (50) to hold the blade (50) longitudinally relative to the handle (60). The cutting edge (53) of the blade (50) allows a user to cut an object. The serrated edge (54) of the blade (50) allows the user to cut or saw an object. However, the cutting edge (53) and the serrated edge (54) of the blade (50) are both formed on the bottom edge of the blade (50), the user needs to keep the serrated edge (54) from sawing an object when the object is cut with the cutting edge (53) to make the cut edge on the object neat.

In addition, length of the bottom edge of the blade (50) is limited so that length of the cutting edge (53) and length of the serrated edge (54) are dependent upon with each other. In order to saw an object into two pieces, the user needs to perform multiple back and forth actions with a shortened serrated edge (54) on the bottom edge with a limited length. Furthermore, a shortened cutting edge (53) of the blade (50) is also inconvenient in cutting or slicing an object.

To overcome the shortcomings, the present invention provides a pocketknife with a folding blade and a secondary blade to obviate or mitigate the aforementioned problems.

### SUMMARY OF THE INVENTION

The primary objective of the present invention is to provide pocketknife with a folding blade and a secondary blade that will cut or slice things more conveniently.

A pocketknife with a folding blade and a secondary blade in accordance with the present invention has a handle, a folding blade, a bracket and a secondary blade. The handle has a side. The folding blade is connected pivotally to the handle and has a bottom edge and a cutting edge. The cutting edge is smooth and is formed on the bottom edge of the folding blade. The bracket is mounted on the side of the handle. The secondary blade is mounted slidably inside the bracket and has a bottom edge and a cutting edge. The cutting edge is formed on the bottom edge of the secondary blade, is irregular and may be serrated or saw-toothed. The cutting edges on the blades are separated from each other. The cutting edge of the secondary blade cannot interfere with the smooth cutting edge of the folding blade when the smooth cutting edge of the folding blade slices things. The cutting edge of the secondary blade is long enough to cut or saw through an object in a few strokes.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a pocketknife with a folding blade and a secondary blade in accordance with the present invention;

FIG. 2 is an operational perspective view of the pocketknife in FIG. 1 when the secondary blade is pushed out of a bracket;

FIG. 3 is an operational top view in partial section of the pocketknife in FIG. 2;

FIG. 4 is an operational top view of the pocket knife in FIG. 1 when the secondary blade is retracted into the bracket;

FIG. 5 is an exploded perspective view of a second embodiment of the pocketknife with a folding blade and a secondary blade in accordance with the present invention;

FIG. 6 is an operational perspective view of the pocketknife in FIG. 5 when the secondary blade is pushed out of the bracket;

FIG. 7 is a perspective view of a conventional pocketknife with a folding blade in accordance with the prior art with the folding blade extended; and

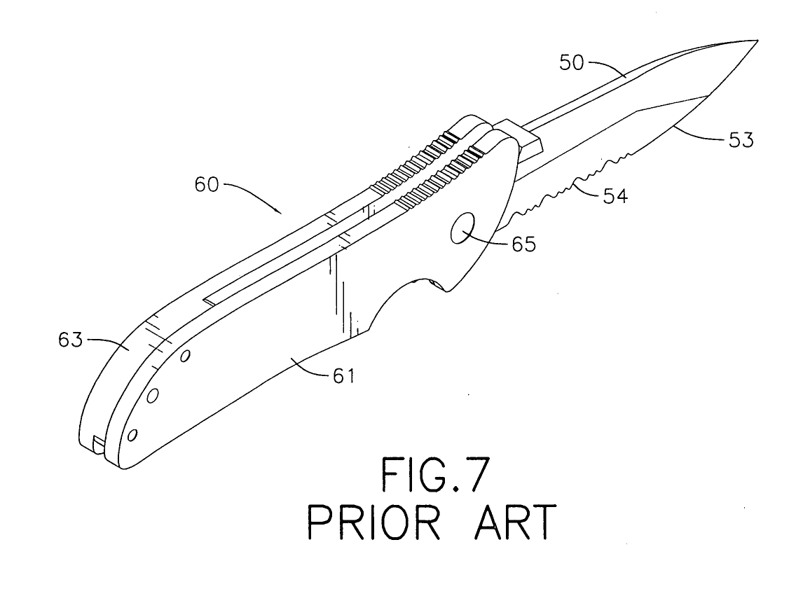

FIG. 8 is an exploded perspective view of the pocketknife in FIG. 7;

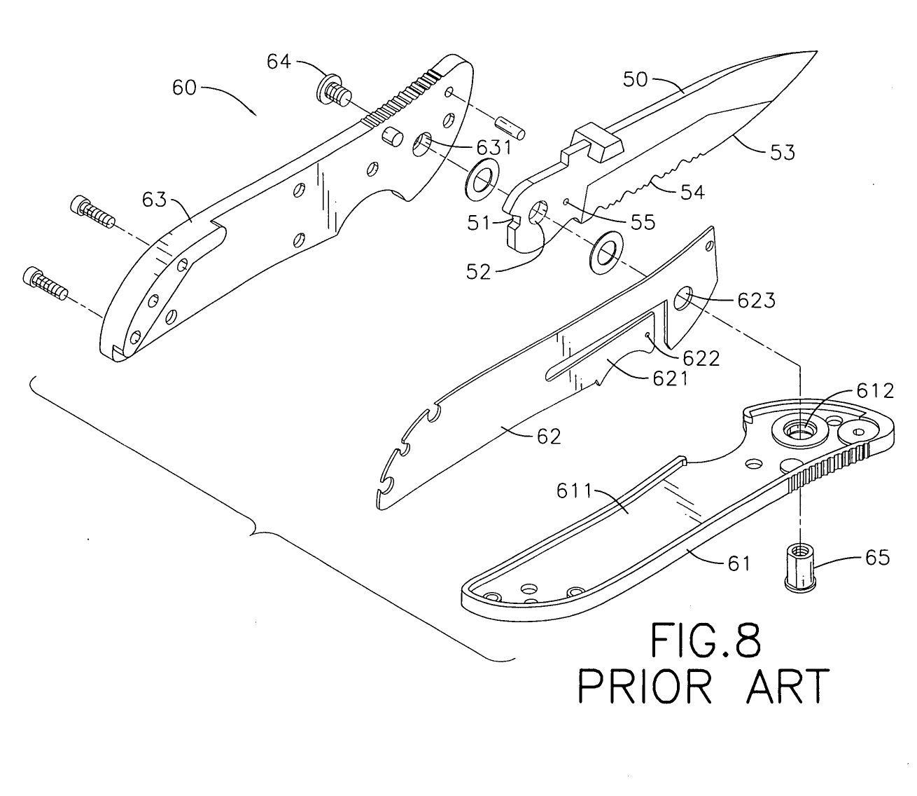

### DETAILED DESCRIPTION OF THE PREFERRED EMBODIMENT

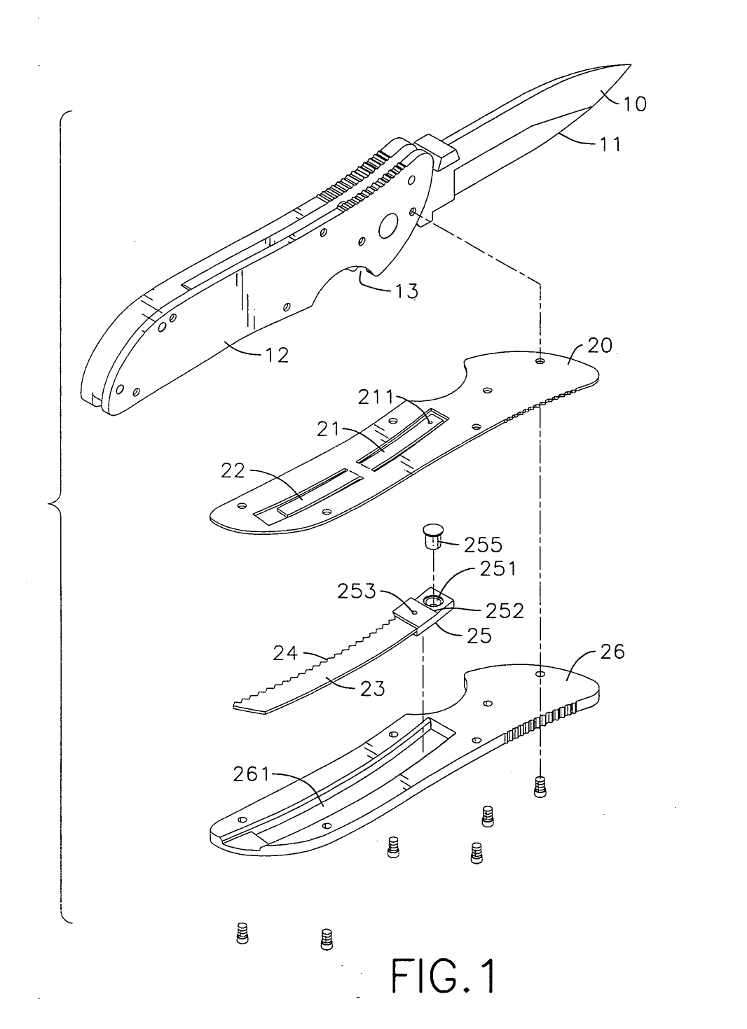

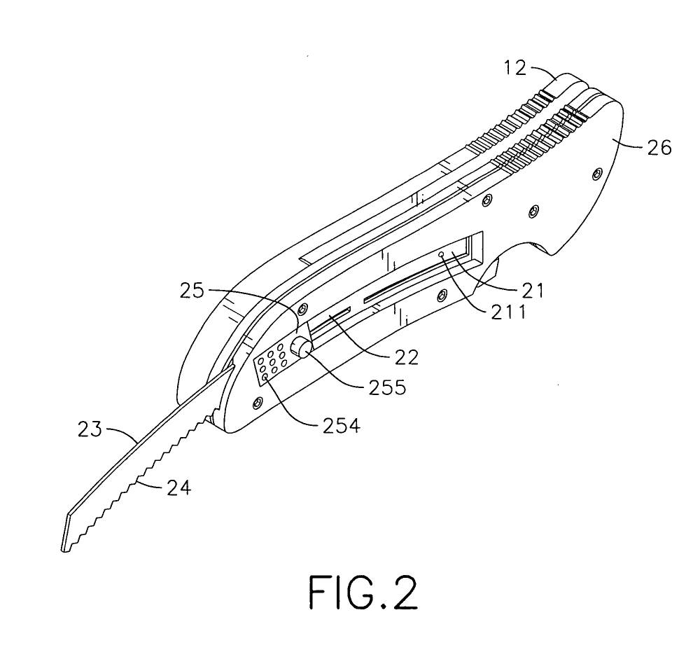

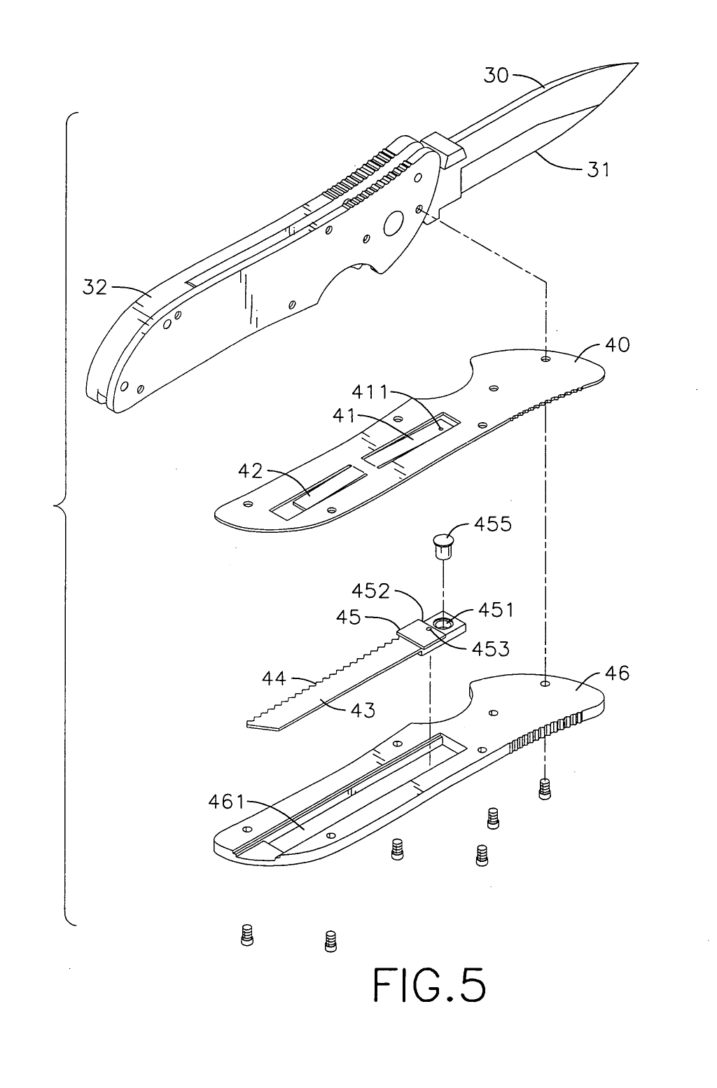

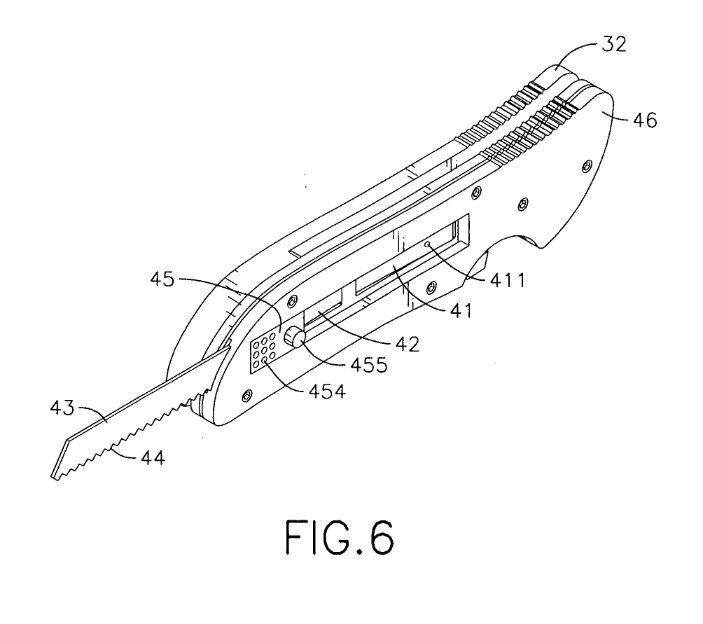

With reference to FIGS. 1, 2, 5 and 6, a pocketknife with a folding blade and a secondary blade in accordance with the present invention comprises a handle (12, 32), a folding blade (10, 30), a bracket base (20, 40), a bracket (26, 46) and a secondary blade (23, 43).

The handle (12, 32) has a bottom, a recess (13), a front end and a side. The recess (13) is formed in the bottom of the handle (12, 32).

The folding blade (10, 30) is attached pivotally to the front end of the handle (12, 32), is folded into and stored in the recess (13) in the handle (12, 32) and has a rear end, a bottom edge and a cutting edge (11, 31). The rear end of the folding blade (10, 30) is attached pivotally to the front end of the handle (12, 32). The cutting edge (11, 31) may be smooth and is formed on the bottom edge of the folding blade (10, 30).

The bracket base (20, 40) is mounted on the side of the handle (12, 32) and has a side, a rear end, a front end, an optional retracted latch (21, 41) and an extended latch (22, 42). The retracted latch (21, 41) is formed on the side of the bracket base (20, 40), may be curved or straight, extends toward the front end of the bracket base (20, 40) and may have a side and a protruding latch (211, 411). The protruding latch (211, 411) is formed on the side of the retracted latch (21, 41). The extended latch (22,42) is formed on the side of the bracket base (20,40), may be curved or straight, extends toward the rear end of the bracket base (20, 40) and has a rear end.

The bracket (26, 46) is mounted on the side of the bracket base (20, 40) and has an inner side and a guide hole (261, 461). The guide hole (261, 461) is formed through the bracket (26, 46) and may be curved or straight and wedge or step shaped.

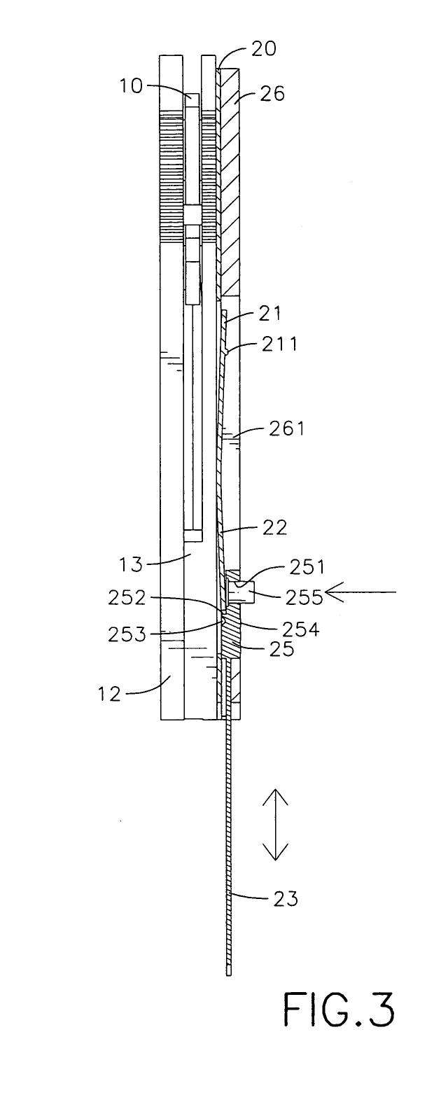

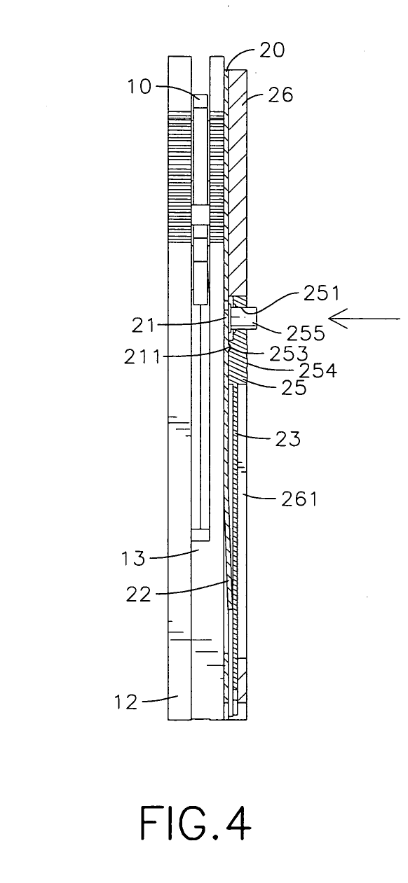

The secondary blade (23, 43) is mounted slidably in the guide hole (261, 461) in the bracket (26, 46), may be curved or straight and has a rear end, a bottom edge, an irregular cutting edge (24, 44) and a sliding seat (25, 45). The irregular cutting edge (24, 44) is formed on the bottom edge of the secondary blade (23, 43) and may be saw-toothed or serrated. The sliding seat (25, 45) is attached to the rear end of the secondary blade (23, 43) and has a bottom, a hole (251, 451), a bottom edge (252, 452), an optional notch (253, 453), an outer face (254, 454) and a pushing rod (255, 455). The hole (251, 451) is formed through the sliding seat (25, 45) and may have an annular shoulder. The annular shoulder is formed on the bottom of the sliding seat (25, 45) around the hole (251, 451). The bottom edge (252, 452) is formed on the bottom of the sliding seat (25, 45) and selectively engages the rear end of the extended latch (22, 42) of the bracket base (20, 40) to hold the secondary blade (23, 43) in an extended condition. The notch (253, 453) is formed on the bottom of the sliding seat (25, 45) near the bottom edge (252, 452) and selectively engages the protruding latch (211, 411) of the bracket base (20, 40). The outer face (254, 454) may be rough. The pushing rod (255, 455) is mounted slidably in the hole (251, 451) in the sliding seat (25, 45), has an inner end and may have a flange. The flange is formed on and protrudes radially out from the inner end and corresponds to the annular shoulder around the hole (251, 451) in the sliding seat (25, 45). With further reference to FIGS. 3 and 4, the secondary blade (24, 44) is extended from the guide hole (261, 461) by pressing the pushing rod (255, 455) in and toward the rear of the handle (12, 32) so the inner end of the pushing rod (255, 455) presses against the retracted latch (21, 41) to disengage the protruding latch (211, 411) from the notch (253, 453) and the secondary blade (24, 44) protrudes from the guide hole (261, 461). The secondary blade (23,43) is retracted into the guide hole (261, 461) by pressing the pushing rod (255, 455) in and toward the front of the handle (12, 32) so the inner end of the pushing rod (255, 455) presses against the extended latch (22, 42) to disengage the bottom edge (252, 452) from the extended latch (22, 42).

Consequently, the cutting edge (11, 31) and the serrated edge (24, 44) are defined respectively on the folding blade (10, 30) and the secondary blade (23, 43) so that the serrated edge (24, 44) of the secondary blade (23, 43) and cannot interfere with each other when cutting objects. Furthermore, the cutting edge (11, 31) of the secondary blade (23, 43) is long enough to cut things with just a few strokes of the secondary blade (23, 43).

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A pocketknife comprising
a handle having
a bottom;
a recess being formed on the bottom of the handle;
a front end; and
a side;
a folding blade being attached pivotally to the front end of the handle to be folded into and stored in the recess in the handle and having
a rear end being attached pivotally to the front end of the handle;
a bottom edge; and
a cutting edge being formed on the bottom edge of the folding blade;
a bracket base being mounted on the side of the handle and having
a side;
a rear end;
a front end;
an extended latch being formed on the side of the bracket base, extending toward the rear end of the bracket base and having a rear end;
a bracket being mounted on the side of the bracket base and having
an inner side; and
a guide hole being formed through the bracket; and
a secondary blade being mounted slidably in the guide hole in the bracket and having
a rear end;
a bottom edge;
a cutting edge being formed on the bottom edge of the secondary blade; and
a sliding seat being attached to the rear end of the secondary blade and having
a bottom;
a hole being formed through the sliding seat;
a bottom edge being formed on the bottom of the sliding seat and selectively engaging the rear end of the extended latch of the bracket base;
an outer face; and
a pushing rod being mounted slidably in the hole in the sliding seat and having an inner end.

2. The pocketknife as claimed in claim 1, wherein
the bracket base further has a retracted latch formed on the side of the bracket base and extending toward to the front end of the bracket base and having
a side; and
a protruding latch formed on the side of the retracted latch; and
the sliding seat of the secondary blade further has a notch formed on the bottom of the sliding seat near the bottom edge of the sliding seat and selectively engages the protruding latch of the bracket base.

3. The pocketknife as claimed in claim 2, wherein
the extended latch of the bracket base is curved;
the retracted latch of the bracket base is curved;
the secondary blade is curved; and
the guide hole in the bracket is curved.

4. The pocketknife as claimed in claim 2, wherein
the extended latch of the bracket base is straight;
the retracted latch of the bracket base is straight;
the secondary blade is straight; and
the guide hole in the bracket is straight.

5. The pocketknife as claimed in claim 3, wherein the guide hole the bracket is wedge-shaped.

6. The pocketknife as claimed in claim 4, wherein the guide hole in the bracket is step-shaped.

7. The pocketknife as claimed in claim 5, wherein
the hole in the sliding seat has an annular shoulder formed on the bottom of the sliding seat around the hole; and corresponding to the annular shoulder around the hole in the sliding seat; and
the pushing rod of the sliding seat has a flange formed on and protruding radially out from the inner end of the pushing rod and corresponding to the annular shoulder around the hole in the sliding seat.

8. The pocketknife as claimed in claim 7, wherein the outer face of the sliding seat is rough.

9. The pocketknife as claimed in claim 1, wherein the cutting edge of the folding blade is smooth.

10. The pocketknife as claimed in claim 1, wherein the cutting edge of the secondary blade is serrated.

11. The pocketknife as claimed in claim 1, wherein the cutting edge of the secondary blade is saw-toothed.
